(19) United States
(12) Patent Application Publication
(10) Pub. No.: US 2013/0003979 A1
(43) Pub. Date: Jan. 3, 2013

(54) APPARATUS AND METHOD FOR GENERATING MULTIPLE OUTPUT SEQUENCE

(75) Inventors: Chan Bok JEONG, Daejeon (KR); Dae Ho KIM, Daejeon (KR)

(73) Assignee: Electronics & Telecommunications Research Institute, Daejeon (KR)

(21) Appl. No.: 13/456,053

(22) Filed: Apr. 25, 2012

(30) Foreign Application Priority Data
Jun. 30, 2011 (KR) 10-2011-0065188
Mar. 19, 2012 (KR) 10-2012-0027900

(51) Int. Cl. H04K 1/04

(52) U.S. Cl. 380/287

(57) ABSTRACT

Provided are an apparatus and method for generating a multiple output sequence. The apparatus includes an update unit configured to update a first shift register having k stages by inputting a value to the first shift register at every clock, a transfer unit configured to simultaneously transfer, at every clock, output values output from the first shift register to k stages of a second shift register respectively and output values output from k stages of the second shift register to k stages of a third shift register having the k stages respectively, and a multiple output generator configured to generate a multiple output sequence by outputting values of the k stages of the third shift register at every clock.

### CLAIM FOR PRIORITY

This application claims priority to Korean Patent Applications No. 10-2011-0065188 filed on Jun. 30, 2011 and No. 10-2012-0027900 filed on Mar. 19, 2012 in the Korean Intellectual Property Office (KIPO), the entire contents of which are hereby incorporated by reference.

### BACKGROUND

1. Technical Field

Example embodiments of the present invention relate in general to an apparatus and method for generating a multiple output sequence, an apparatus and method for generating a scrambling sequence, and a data processing method, and more particularly, to an apparatus and method for generating a multiple output sequence using outputs of a linear feedback shift register (LFSR).

2. Related Art

Scrambling code is used to identify user equipment (UE)-specific and cell (base station)-specific identification information in a wireless communication system. In general, a base station is identified in a downlink, and UE is identified in an uplink.

Such scrambling code serves to randomize or decrease the interference in each UE or cell caused by another UE or cell, and may be used as a method for increasing cell capacity.

In the case of a Third Generation Partnership Project (3GPP) Long Term Evolution (LTE) system, scrambling code is applied in common to respective physical channels and physical signals of an uplink and downlink. For example, during the process of an uplink physical channel in a 3GPP LTE system, each bit passing through channel coding is scrambled with signs generated by a scrambling generator in a bit-to-bit manner through a modulo-2 operation.

The scrambled bits are input to a modulation mapper and mapped to complex-valued symbols by modulation schemes such as quadrature phase shift keying (QPSK), 16 quadrature amplitude modulation (16QAM) and 64QAM.

During the process of a downlink physical channel in the 3GPP LTE system, bits that pass through channel coding and are input in the form of code words are scrambled and then input to the modulation mapper, similarly to the uplink.

In general, the aforementioned scrambling code is generated on the basis of a pseudo-random sequence having excellent correlation characteristics. Well-known pseudo-random sequences include an m-sequence, a Gordon-Mills-Welch (GMW) sequence, a Legendre sequence, and so on. The m-sequence may be converted into a primitive polynomial of degree m over GF(2), which can be easily implemented using one LFSR.

However, in the case of a 3.9G (Pre-4G) LTE system developed from 3G wideband code division multiple access (WCDMA) technology, time that can be used for a scrambling/descrambling process of high-speed mass data transmission is very short in comparison with a data length of N-bits. Thus, it is difficult to perform the function within a limited processing time using an existing method, and efficient implementation is impossible.

### SUMMARY

Accordingly, example embodiments of the present invention are provided to substantially obviate one or more problems due to limitations and disadvantages of the related art.

Example embodiments of the present invention provide a method of generating a multiple output sequence using outputs of a linear feedback shift register (LFSR).

Example embodiments of the present invention also provide an apparatus for generating a multiple output sequence.

Example embodiments of the present invention also provide a method of generating a scrambling sequence using the multiple output sequence.

Example embodiments of the present invention also provide an apparatus for generating a scrambling sequence.

Example embodiments of the present invention also provide a data processing method in which a channel or signal is scrambled or descrambled using the scrambling sequence.

In some example embodiments, a method of generating a multiple output sequence includes: updating a first shift register having k stages by inputting a value to the first shift register at every clock; simultaneously transferring, at every clock, output values output from the first shift register to k stages of a second shift register respectively and output values output from k stages of the second shift register to k stages of a third shift register having the k stages respectively; and generating a multiple output sequence by outputting values of the k stages of the third shift register at every clock.

Updating the first shift register may include updating the k stages of first shift register using a result value obtained by performing a modulo operation on at least one output value from the stages of the first, second and third shift registers. Here, the modulo operation may be a modulo-2 operation.

Generating the multiple output sequence may include generating the multiple output sequence by simultaneously outputting the values of the k stages of the third shift register.

In other example embodiments, an apparatus for generating a multiple output sequence includes: an update unit configured to update a first shift register having k stages by inputting a value to the first shift register at every clock; a transfer unit configured to simultaneously transfer, at every clock, output values output from the first shift register to k stages of a second shift register respectively and output values output from k stages of the second shift register to k stages of a third shift register having the k stages respectively; and a multiple output generator configured to generate a multiple output sequence by outputting values of the k stages of the third shift register at every clock.

At least one stage of the first, second and third shift registers may be connected to a modulo operation unit through a switch. Here, the update unit may update the k stages of the first shift registers by inputting an output of the at least one modulo operation unit to the k stages of the first shift register.

In other example embodiments, a method of generating a scrambling sequence using a shift register including first, second and third stage units each having at least one stage includes: simultaneously transferring, at every clock, output values output from a first shift register to k stages of a second shift register respectively and output values output from k stages of the second shift register to k stages of a third shift register having the k stages respectively, and outputting a multiple output sequence from the shift register by updating the first stage unit using outputs of some stages of the first, second and third stage units; and generating a scrambling sequence using the at least one multiple output sequence.

In other example embodiments, a data processing method includes: as a step of generating a scrambling sequence using a shift register including first, second and third stage units each having at least one stage, simultaneously transferring, at every clock, output values output from a first shift register to k stages of a second shift register respectively and output values output from k stages of the second shift register to k stages of a third shift register having the k stages respectively, and outputting a multiple output sequence from the shift register by updating the first stage unit using outputs of some stages of the first, second and third stage units; generating a scrambling sequence using the at least one multiple output sequence; and scrambling or descrambling at least one channel or signal using the scrambling sequence.

In other example embodiments, an apparatus for generating a scrambling sequence using a shift register including first, second and third stage units each having at least one stage includes: a multiple output sequence generator configured to simultaneously transfer, at every clock, outputs from stages of the first stage unit to at least some stages of the second stage unit and outputs from at least some stages of the second stage unit to the third stage unit, update the first stage unit using outputs of some stages of the first, second and third stage units, and output a multiple output sequence from the shift register; and a scrambling sequence generator configured to generate a scrambling sequence using the at least one multiple output sequence.

### BRIEF DESCRIPTION OF DRAWINGS

Example embodiments of the present invention will become more apparent by describing in detail example embodiments of the present invention with reference to the accompanying drawings, in which:

FIG. 1 shows a structure of a general linear feedback shift register (LFSR);

FIG. 2 illustrates an apparatus for generating a multiple output sequence and an apparatus for generating a scrambling sequence according to an example embodiment of the present invention; and

FIG. 3 is a flowchart illustrating a process of generating a multiple output sequence and a data processing method according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like elements refer to like numerals throughout the drawings.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in detail with reference to accompanying drawings.

An apparatus and method for generating a multiple output sequence proposed herein can be used in various wireless communication systems such as code division multiple access (CDMA), time division multiple access (TDMA), frequency division multiple access (FDMA), orthogonal frequency division multiple access (OFDMA), single-carrier FDMA (SC-FDMA), and other systems. The terms “system” and “network” used herein are often used interchangeably.

A CDMA system implements wireless technology such as Universal Terrestrial Radio Access (UTRA) and CDMA2000. UTRA includes wideband CDMA (WCDMA) and other modifications of CDMA. CDMA2000 covers Interim standard (IS)-2000, IS-95 and IS-856 standards. A TDM system can implement radio technology such as Global System for Mobile Communication (GSM).

An OFDMA system can implement radio technology such as evolved UTRA (E-UTRA), Ultra Mobile Broadband (UMB), Institute of Electrical and Electronics Engineers (IEEE) 802.11 (Wireless-Fidelity (Wi-Fi)), IEEE 802.16 (Worldwide Interoperability for Microwave Access (WiMAX)), IEEE 802.20, and flash-orthogonal frequency division multiplexing (OFDM).

UTRA and E-UTRA are part of Universal Mobile Telecommunications System (UMTS). 3GPP-LTE that uses OFDMA in a downlink and SC-FDMA in an uplink is an upcoming release of UMTS that uses E-UTRA.

UTRA, E-UTRA, UMTS, LTE and GSM are described in documents from the organization “3GPP.” CDMA2000 and UMB are described in documents from the organization “Third Generation Partnership Project 2 (3GPP2).” For clarity, certain aspects of the technology are described below for LTE, and LTE terminology is frequently used in the description below.

LTE uses OFDM in a downlink and SC-FDM in an uplink. OFDM and SC-FDM can divide a system bandwidth into multiple (K) orthogonal subcarriers, which are commonly referred to as tons, bins, etc.

Each subcarrier can be modulated into data. In general, modulation symbols are transmitted in the frequency domain by OFDM and in the time domain by SC-FDM. The interval between adjacent subcarriers may be fixed, and the total number K of subcarriers may depend on the system bandwidth. For example, K may be 128, 256, 512, 1024 or 2048 for a system bandwidth of 1.25, 2.5, 5, 10 or 20 MHz, respectively.

Scrambling may be performed for various channels and signals in a transmitter side. It is preferable to relate scrambling sequences for some channels/signals to resource elements or blocks occupied by the channels/signals. It is more preferable to separate scrambling sequences for other channels/signals from the occupied resource elements or blocks.

Descrambling may be performed in a receiver side to restore scrambling performed by a transmitter to the original state. Descrambling may be performed using the same scrambling sequence as used for scrambling in the transmitter side. It is preferable to efficiently generate scrambling sequences for different channels/signals.

A process of generating a scrambling sequence that can be used for scrambling and descrambling of different channels and signals will be described below A binary maximum length sequence (MLS) commonly referred to as m-sequence can be used as a base scrambling sequence.

The m-sequence may be generated by a linear feedback shift register (LFSR) that implements a primitive polynomial. The length of the m-sequence needs to be long enough, and a generator polynomial f(x) of the m-sequence may be represented by [Equation 1].

f(x)=x^{N}+c_{N-1}x^{N-1}+c_{N-2}x^{N-2}+L+c₁x¹+L+c₂x²+c₁x+1 c₁εGF(2) [Equation 1]

Referring to [Equation 1], f(x) is configured as a shift register and generates an output of the LFSR so that data can be scrambled/descrambled at every clock. c denotes a coefficient of the generator polynomial, x^{N}, x^{N-1}, x^{N-2}, . . . , x² and x respectively denote outputs of first to last delays in the LFSR, and N denotes the degree, that is, maximum order, of f(x).

In general, the generator polynomial f(x) of an appropriate degree can be used for the base scrambling sequence. Since the generator polynomial f(x) can be used for all channels and signals, reconfiguration of the LFSR can be avoided. The LFSR may be set to the same initial state for all the channels and signals.

Different circular shifts of the base scrambling sequence may be obtained by a modulo-2 adder that adds different combinations of outputs of the LFSR.

Specific LFSR outputs input to the modulo-2 adder are determined through a preferable circular shift. Alternatively, the preferable circular shift may be achieved by a modulo-2 adder that adds certain combinations of outputs of the LFSR and by setting different initial states. At least one LFSR may be used, and the generated outputs may be results of modulo-2 addition for obtaining the preferable scrambling sequence.

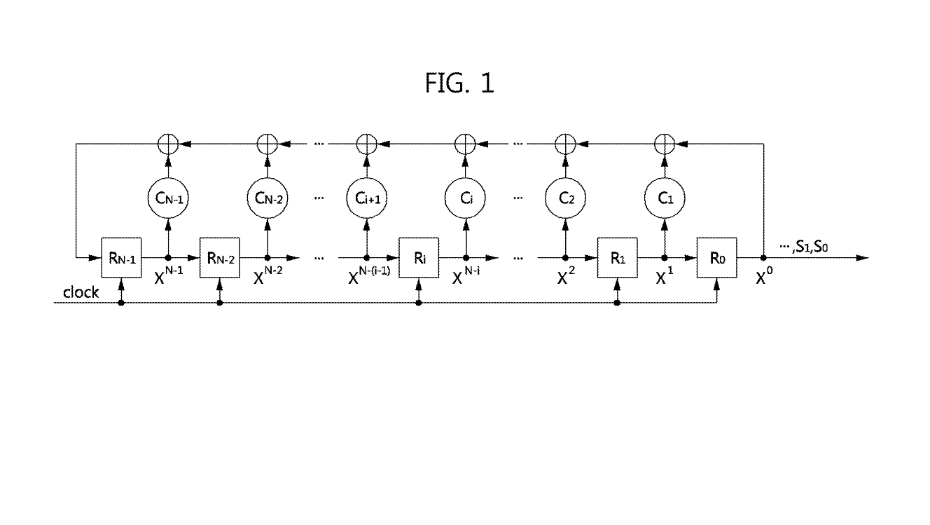

FIG. 1 shows a structure of an LFSR. In FIG. 1, R_{N-1}, R_{N-2}, . . . , and R₀ denote stages of the shift register respectively, and C_{N-1}, C_{N-2}, . . . , and C₁ denote coefficients of the generator polynomial, serving as switches. N denotes the degree, that is, maximum order, of f(x). As a tap of the shift register, the output of each stage Rᵢ is connected to a modulo-2 adder through a switch Cᵢ, and each stage Rᵢ may denote a power term x′ of f(x).

When xᵢ(t) in f(x) denotes a number stored in Rᵢ after a clock pulse t, xᵢ(t+1) denotes a value stored in Rᵢ after a clock pulse (t+1) and is defined as shown in [Equation 2].

$${x}_{0} ( t + 1 ) = {x}_{1} ( t ) \\ {x}_{1} ( t + 1 ) = {x}_{2} ( t ) \\ ⋮ \\ {x}_{N - 3} ( t + 1 ) = {x}_{N - 2} ( t ) \\ {x}_{N - 2} ( t + 1 ) = {x}_{N - 1} ( t ) \\ {x}_{N - 1} ( t + 1 ) = {x}_{0} ( t ) + {c}_{1} {x}_{1} ( t ) + {c}_{2} {x}_{2} ( t ) + {c}_{3} {x}_{3} ( t ) + … + {c}_{N - 3} {x}_{N - 3} ( t ) + {c}_{N - 2} {x}_{N - 2} ( t ) + {c}_{N - 1} {x}_{N - 1} ( t ) \qquad [ Equation 2 ]$$

As shown in FIG. 1, a processing method of scrambling/descrambling data using an output of a general LFSR requires N-clock pulses for data having a length of N bits.

Thus, time that can be used for a scrambling/descrambling process for high-speed mass data transmission in an LTE-Advanced system, etc. is very short in comparison with a data length of N-bits. Thus, it is difficult to perform the function within a limited processing time using this method, and efficient implementation is impossible.

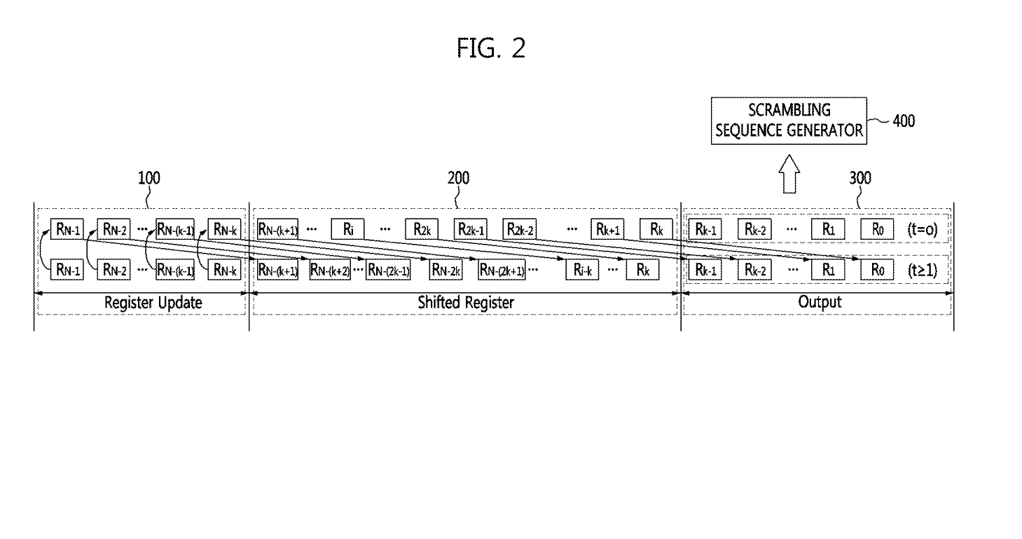

An apparatus for generating a multiple output sequence according to an example embodiment of the present invention for solving such a problem will be described in detail below with reference to FIG. 2.

FIG. 2 illustrates an apparatus for generating a multiple output sequence and an apparatus for generating a scrambling sequence according to an example embodiment of the present invention.

Referring to FIG. 2, an apparatus for generating a multiple output sequence may include a register update unit 100, a transfer unit 200, and a multiple output generator 300. Also, an apparatus for generating a scrambling sequence according to an example embodiment of the present invention may include a scrambling sequence generator 400 in addition to the apparatus for generating a multiple output sequence.

R_{N-1}, R_{N-2}, . . . , and R₀ included in the register update unit 100, the transfer unit 200 and the multiple output generator 300 denote stages of a shift register.

For convenience, stages included in the register update unit 100 will be referred to as stage unit 1, those included in the transfer unit 200 will be referred to as stage unit 2, and those included in the multiple output generator 300 will be referred to as stage unit 3. In other words, the shift register may include stage unit 1, stage unit 2 and stage unit 3. Also, stage unit 1, stage unit 2 and stage unit 3 may be referred to as first, second and third shift registers, respectively. In this case, the first, second and third shift registers may integratedly constitute the shift register according to an example embodiment of the present invention.

Although not shown in FIG. 2, C_{N-1}, C_{N-2}, . . . , and C₁ denote coefficients of f(x), serving as switches, the output of each stage Rᵢ is connected to a modulo-2 adder through a switch Cᵢ as a tap of the shift register, and each stage Rᵢ denotes a power term xⁱ of f(x).

In an example embodiment of the present invention, a multiple output range of k bits that can be generated by an LFSR at every clock is 1≦k≦(N−J) bits. N denotes the degree, that is, maximum order, of f(x), and J is the second maximum order of f(x). A process of generating k-bit multiple outputs of the LFSR at every clock is defined as shown in [Equation 3].

$${x}_{0} ( t + 1 ) = {x}_{k} ( t ) \\ {x}_{1} ( t + 1 ) = {x}_{k + 1} ( t ) \\ ⋮ \\ {x}_{N - ( k + 2 )} ( t + 1 ) = {x}_{N - 2} ( t ) \\ {x}_{N - ( k + 1 )} ( t + 1 ) = {x}_{N - 1} ( t ) \\ {x}_{N - k} ( t + 1 ) = {x}_{0} ( t ) + {c}_{1} {x}_{1} ( t ) + {c}_{2} {x}_{2} ( t ) + {c}_{3} {x}_{3} ( t ) + … + {c}_{N - ( k + 2 )} {x}_{N - ( k + 2 )} ( t ) + {c}_{N - ( k + 1 )} {x}_{N - ( k + 1 )} ( t ) + {c}_{N - k} {x}_{N - k} ( t ) \\ {x}_{N - ( k - 1 )} ( t + 1 ) = {x}_{1} ( t ) + {c}_{1} {x}_{2} ( t ) + {c}_{2} {x}_{3} ( t ) + {c}_{3} {x}_{4} ( t ) + … + {c}_{N - ( k + 2 )} {x}_{N - ( k + 1 )} ( t ) + {c}_{N - ( k + 1 )} {x}_{N - k} ( t ) + {c}_{N - k} {x}_{N - ( k - 1 )} ( t ) \\ ⋮ \\ {x}_{N - 2} ( t + 1 ) = {x}_{k - 2} ( t ) + {c}_{1} {x}_{k - 1} ( t ) + {c}_{2} {x}_{k} ( t ) + {c}_{3} {x}_{k + 1} ( t ) + … + {c}_{N - ( k + 2 )} {x}_{N - 4} ( t ) + {c}_{N - ( k + 1 )} {x}_{N - 3} ( t ) + {c}_{N - k} {x}_{N - 2} ( t ) \\ {x}_{N - 1} ( t + 1 ) = {x}_{k - 1} ( t ) + {c}_{1} {x}_{k} ( t ) + {c}_{2} {x}_{k + 1} ( t ) + {c}_{3} {x}_{k + 2} ( t ) + … + {c}_{N - ( k + 2 )} {x}_{N - 3} ( t ) + {c}_{N - ( k + 1 )} {x}_{N - 2} ( t ) + {c}_{N - k} {x}_{N - 1} ( t ) \qquad [ Equation 3 ]$$

Referring to [Equation 3], when xᵢ(t) is a number stored in Rᵢ after a clock pulse t, x₀(t+1) denotes a value stored in Rᵢ after a clock pulse (t+1). FIG. 2 shows [Equation 3] configured in the form of a shift register. The register update unit 100 updates stages {R_{N-1}, R_{N-2}, . . . , R_{N-k}} at every clock.

At every clock, the transfer unit 200 transfers output values from stages {R_{N-(k+1}), R_{N-(k+2)}, . . . , Rₖ} to stages {R_{N-(2k+1)}, . . . , Rₖ} and stages {Rₖ₋₁, Rₖ₋₂, . . . , R₀} of the multiple output generator 300, then it is updated by output values from the stages {R_{N-1}, R_{N-2}, . . . , R_{N-k}} of the register update unit 100.

At every clock, the multiple output generator 300 outputs the stages {Rₖ₋₁, Rₖ₋₂, . . . , R₀}, thereby generating k-bit multiple outputs of the LFSR. In this way, the register update unit 100, the transfer unit 200 and the multiple output generator 300 may be reconfigured in the form of a vector and matrix as shown in [Equation 4] and [Equation 5].

$$\begin{matrix}X ( t + 1 ) = {T}_{S} X ( t ) & [ Equation 4 ] \\ X ( t + 1 ) = [ \begin{matrix}{x}_{0} ( t + 1 ) \\ {x}_{1} ( t + 1 ) \\ ⋮ \\ {x}_{N - ( k + 2 )} ( t + 1 ) \\ {x}_{N - ( k + 1 )} ( t + 1 ) \\ {x}_{N - k} ( t + 1 ) \\ {x}_{N - ( k - 1 )} ( t + 1 ) \\ ⋮ \\ {x}_{N - 2} ( t + 1 ) \\ {x}_{N - 1} ( t + 1 )\end{matrix} ] , X ( t ) = [ \begin{matrix}{x}_{0} ( t ) \\ {x}_{1} ( t ) \\ ⋮ \\ {x}_{N - ( k + 2 )} ( t ) \\ {x}_{N - ( k + 1 )} ( t ) \\ {x}_{N - k} ( t ) \\ {x}_{N - ( k - 1 )} ( t ) \\ ⋮ \\ {x}_{N - 2} ( t ) \\ {x}_{N - 1} ( t )\end{matrix} ] & [ Equation 5 ]\end{matrix}$$

Referring to [Equation 4] and [Equation 5], column vectors X(t) and X(t+1) denote stages of a shift register after clock pulses t and (t+1) respectively, and Tₛ denotes a characteristic matrix of the LFSR proposed according to an example embodiment of the present invention. Further, xᵢ(t) denotes a value stored in Ri after clock pulse t. The characteristic matrix Tₛ of the LFSR proposed according to an example embodiment of the present invention will be described below.

$$\begin{matrix}{T}_{S} = [ \begin{matrix}[ {T}_{S , 1} ] \\ [ {T}_{S , 2} ]\end{matrix} ] & [ Equation 6 ] \\ {T}_{S , 1} = [ \overbrace{\begin{matrix}0 & 0 & 0 & … & 0 & 0 \\ 0 & 0 & 0 & … & 0 & 0 \\ & ⋮ & & & & ⋮ \\ 0 & 0 & 0 & … & 0 & 0 \\ 0 & 0 & 0 & … & 0 & 0\end{matrix}}^{K} \overbrace{\begin{matrix}1 & 0 & 0 & … & 0 & 0 & 0 \\ 0 & 1 & 0 & … & 0 & 0 & 0 \\ & ⋮ & & & & ⋮ & \\ 0 & 0 & 0 & … & 0 & 1 & 0 \\ 0 & 0 & 0 & … & 0 & 0 & 1\end{matrix}}^{N - K} ] & [ Equation 7 ] \\ {T}_{S , 2} = [ \overbrace{\begin{matrix}1 & {c}_{1} & {c}_{2} & … & {c}_{k - 3} & {c}_{k - 2} & {c}_{k - 1} \\ 0 & 1 & {c}_{1} & … & {c}_{k - 4} & {c}_{k - 3} & {c}_{k - 2} \\ & ⋮ & & & & ⋮ & \\ 0 & 0 & 0 & … & 0 & 1 & {c}_{1} \\ 0 & 0 & 0 & … & 0 & 0 & 1\end{matrix}}^{k} \overbrace{\begin{matrix}{c}_{k} & {c}_{k + 1} & … & {c}_{N - ( k + 1 )} & {c}_{N - k} & 0 & 0 & … & 0 & 0 & 0 \\ {c}_{k - 1} & {c}_{k} & … & {c}_{N - ( k + 2 )} & {c}_{N - ( k + 1 )} & {c}_{N - k} & 0 & … & 0 & 0 & 0 \\ ⋮ & & & & ⋮ & & & & & ⋮ & \\ {c}_{2} & {c}_{3} & … & {c}_{N - ( 2 k - 1 )} & {c}_{N - ( 2 k - 2 )} & {c}_{N - ( 2 k - 3 )} & {c}_{N - ( 2 k - 4 )} & … & {c}_{N - ( k + 1 )} & {c}_{N - k} & 0 \\ {c}_{1} & {c}_{2} & … & {c}_{N - 2 k} & {c}_{N - ( 2 k - 1 )} & {c}_{N - ( 2 k - 2 )} & {c}_{N - ( 2 k - 3 )} & … & {c}_{N - ( k + 2 )} & {c}_{N - ( k + 1 )} & {c}_{N - k}\end{matrix}}^{N - k} ] & [ Equation 8 ]\end{matrix}$$

Referring to [Equation 6] to [Equation 8], the characteristic matrix Tₛ of the LFSR proposed according to an example embodiment of the present invention consists of T_{s,1} of [Equation 7] and T_{s,2} of [Equation 8]. At every clock, the transfer unit 200 transfers output values output from the stages {R_{N-(k+1)}, . . . , Rₖ} to the stages {R_{N-(2k+1)}, R_{N-(2k+2)}, . . . , R₀}.

The register update unit 100 updates the stages {R_{N-1}, R_{N-2}, . . . , R_{N-k}} using a k×N matrix, such as [Equation 8], and f(x) at every clock. Then, the multiple output generator 300 outputs the stages {Rₖ₋₁, Rₖ₋₂, . . . , R₀} at every clock, thereby generating k-bit multiple outputs of the LFSR.

A multiple output sequence generated by the multiple output generator 300 is input to the scrambling sequence generator 400. The scrambling sequence generator 400 performs, for example, a modulo-2 operation on the at least one multiple output sequence, thereby generating a scrambling sequence. The generated scrambling sequence may be used to scramble or descramble a channel or signal.

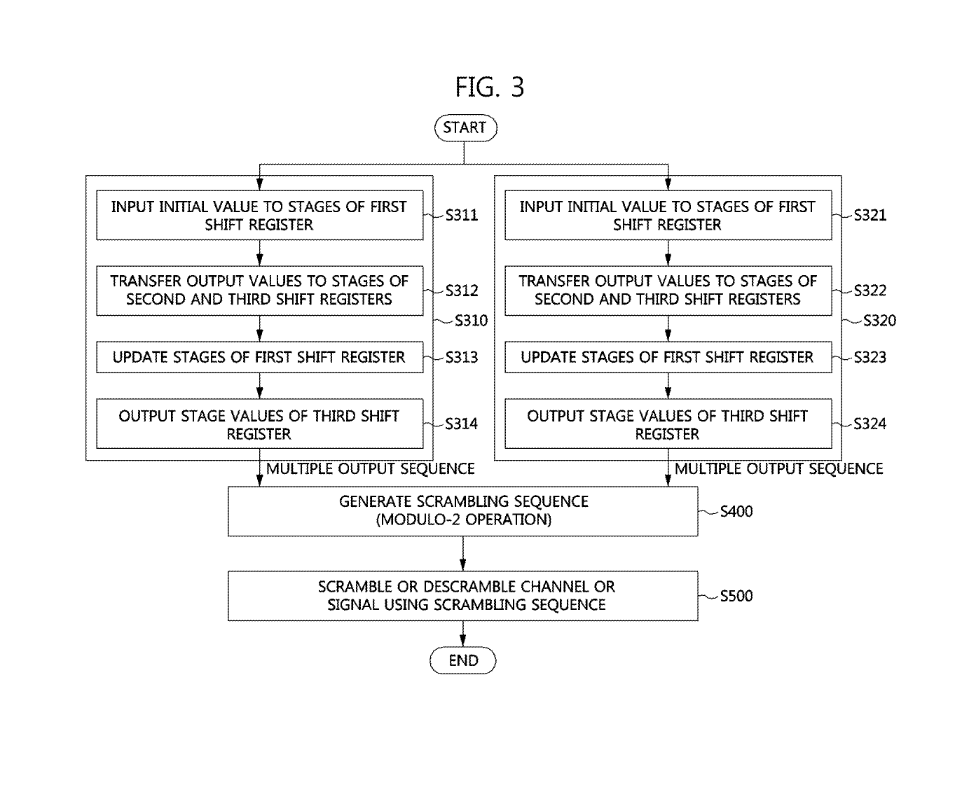

A process of generating a multiple output sequence according to an example embodiment of the present invention will be described in further detail below with reference to FIG. 3.

FIG. 3 is a flowchart illustrating a process of generating a multiple output sequence and a data processing method according to an example embodiment of the present invention.

Referring to FIG. 3, an apparatus for generating a multiple output sequence inputs an initial value to a first shift register having N stages at every clock (S311). Then, the apparatus for generating a multiple output sequence transfers output values output from the stages of the first shift register and K stages of a second shift register to at least one stage of the second shift register and (K−1) stages of a third shift register at every clock (S312).

Subsequently, the apparatus for generating a multiple output sequence updates values of the stages of the first shift register at every clock (S313), and generates a multiple output sequence by outputting values of the stages of the third shift register at every clock (S314).

A plurality of multiple output sequence generation procedures (S310) including the steps S311 to S314 may be performed in parallel (e.g. the steps S321 to S324 in FIG. 3) as illustrated in FIG. 3.

A data processing method according to an example embodiment of the present invention may include a step of generating a scrambling sequence using at least two multiple output sequences generated as mentioned above (S400). In other words, according to an example embodiment of the present invention, a scrambling sequence may be generated using at least two multiple output sequences that are generated using the methods of steps S310 and S320. For example, a scrambling sequence may be obtained by performing a modulo-2 operation on two multiple output sequences generated in the same method.

An example embodiment of the present invention may further include a step of scrambling or descrambling at least one channel or signal using the generated scrambling sequence (S500). At this time, a signal or channel may be processed through scrambling in a transmitter side, and processed through descrambling in a receiver side.

The above-described apparatus and method for generating a multiple output sequence according to example embodiments of the present invention generate a multiple output sequence using outputs of an LFSR, thereby reducing scrambling/descrambling time. Thus, the apparatus and method can smoothly perform the function within a limited processing time, and can be effectively implemented.

While the example embodiments of the present invention and their advantages have been described in detail, it should be understood that various changes, substitutions and alterations may be made herein without departing from the scope of the invention.

What is claimed is:

1. A method of generating a multiple output sequence, comprising:
updating a first shift register having k stages by inputting a value to the first shift register at every clock;
simultaneously transferring, at every clock, output values output from the first shift register to k stages of a second shift register respectively and output values output from k stages of the second shift register to k stages of a third shift register having the k stages respectively; and
generating a multiple output sequence by outputting values of the k stages of the third shift register at every clock.

2. The method of claim 1, wherein updating the first shift register includes updating the k stages of first shift register using a result value obtained by performing a modulo operation on at least one output value from the stages of the first, second and third shift registers.

3. The method of claim 2, wherein the modulo operation is a modulo-2 operation.

4. The method of claim 1, wherein generating the multiple output sequence includes generating the multiple output sequence by simultaneously outputting the values of the k stages of the third shift register.

5. An apparatus for generating a multiple output sequence, comprising:
an update unit configured to update a first shift register having k stages by inputting a value to the first shift register at every clock;
a transfer unit configured to simultaneously transfer, at every clock, output values output from the first shift register to k stages of a second shift register respectively and output values output from k stages of the second shift register to k stages of a third shift register having the k stages respectively; and
a multiple output generator configured to generate a multiple output sequence by outputting values of the k stages of the third shift register at every clock.

6. The apparatus of claim 5, wherein at least one stage of the first, second and third shift registers is connected to a modulo operation unit through a switch.

7. The apparatus of claim 6, wherein the update unit updates the k stages of the first shift registers by inputting an output of the at least one modulo operation unit to the k stages of the first shift register.

8. The apparatus of claim 5, wherein the multiple output generator generates the multiple output sequence by simultaneously outputting the values of the k stages of the third shift register.

9. A method of generating a scrambling sequence using a shift register including first, second and third stage units each having at least one stage, the method comprising:
simultaneously transferring, at every clock, output values output from a first shift register to k stages of a second shift register respectively and output values output from k stages of the second shift register to k stages of a third shift register having the k stages respectively, and outputting a multiple output sequence from the shift register by updating the first stage unit using outputs of some stages of the first, second and third stage units; and
generating a scrambling sequence using the at least one multiple output sequence.

10. The method of claim 9, wherein generating the scrambling sequence includes performing a modulo-2 operation on the at least one multiple output sequence.

11. The method of claim 9, wherein outputting the multiple output sequence includes updating the first stage unit using a result value obtained by performing a modulo operation on at least one output value from the first, second and third stage units.

12. A data processing method, comprising:
as a step of generating a scrambling sequence using a shift register including first, second and third stage units each having at least one stage, simultaneously transferring, at every clock, output values output from a first shift register to k stages of a second shift register respectively and output values output from k stages of the second shift register to k stages of a third shift register having the k stages respectively, and outputting a multiple output sequence from the shift register by updating the first stage unit using outputs of some stages of the first, second and third stage units;
generating a scrambling sequence using the at least one multiple output sequence; and
scrambling or descrambling at least one channel or signal using the scrambling sequence.

13. An apparatus for generating a scrambling sequence using a shift register including first, second and third stage units each having at least one stage, the apparatus comprising:
a multiple output sequence generator configured to simultaneously transfer, at every clock, outputs from stages of the first stage unit to at least some stages of the second stage unit respectively and outputs from at least some stages of the second stage unit to the third stage unit respectively, and output a multiple output sequence from the shift register by updating the first stage unit using outputs of some stages of the first, second and third stage units; and
a scrambling sequence generator configured to generate a scrambling sequence using the at least one multiple output sequence.

14. The apparatus of claim 13, wherein the scrambling sequence generator performs a modulo-2 operation on the at least one multiple output sequence.

15. The apparatus of claim 13, wherein the multiple output sequence generator updates the first stage unit using a result value obtained by performing a modulo operation on at least one output value from the first, second and third stage units.
